(19) United States
(12) Patent Application Publication
(10) Pub. No.: US 2011/0011138 A1
(43) Pub. Date: Jan. 20, 2011

(54) SYSTEMS AND METHOD FOR LOCKING SLIDING DOORS

(76) Inventors: Dennis MacFarland, Abington, MA (US); Clifton E. Hennebury, Abington, MA (US)

Correspondence Address: BURNS & LEVINSON, LLP, 125 SUMMER STREET, BOSTON, MA, 02110, US

(21) Appl. No.: 12/828,723

(22) Filed: Jul. 1, 2010

Related U.S. Application Data
(60) Provisional application No. 61/225,278, filed on Jul. 14, 2009.

(51) Int. Cl. E05B 65/08; E05B 3/00; B21D 47/00

(52) U.S. Cl. 70/99; 292/336.3; 29/897

(57) ABSTRACT

A system and method for locking a sliding door comprising an outside door handle connected to a handle shaft, which in turn operates a security bar mounted on the inside of the sliding door. The door handle is capable of being locked and unlocked from both the inside and the outside of the sliding door.

### CROSS REFERENCE TO RELATED APPLICATIONS

The present application claims priority of co-pending U.S. Provisional Application Ser. No. 61/225,278 filed Jul. 14, 2009 and entitled SYSTEM AND METHOD FOR LOCKING SLIDING DOORS, which is incorporated by reference herein in its entirety for all purposes.

### BACKGROUND

The present teachings relate generally to sliding doors.

Sliding doors include glass patio doors, although not limited thereto, which are used to provide both entry as well as large amounts of light and panoramic view of the outside. They typically comprise a stationary portion and a sliding portion. To open a sliding door, the sliding portion slides back so it is adjacent to the stationary portion. When closed, a lock on the sliding portion may hook on to the door jamb in order to lock sliding door. This type of locking mechanism does not provide much confidence to users, and may be easily “jimmied” or broken.

Security bars are an effective and inexpensive form of security for sliding doors. With sliding glass patio doors, for example, although not limited thereto, security bars provide an effective deterrent for would-be burglars and immediately communicate the locked status of a sliding glass door. One example of a commercially available security bar is known as a “Charley Bar,” and is typically a hinged device that is installed on the inside of the door jamb. When not in use, the security bar can pivot in an upright position parallel to the door jamb and out of the way of the sliding portion of the sliding glass door. When security is needed, the security bar may be pivoted into a horizontal position and its free end may be positioned into a slotted strike plate located on the sliding portion. In this position, the sliding door is restricted from moving because the security bar is resting between the sliding portion and the door jamb.

One failing with security bars is that they can only be controlled from the inside. What is needed, therefore, is a system for locking sliding doors that permits more control of a security bar by a user, in particular, control of the security bar from the exterior of the sliding door.

### SUMMARY

The needs set forth herein as well as further and other needs and advantages are addressed by the present embodiments, which illustrate solutions and advantages described below.

The present teachings include, but are not limited to, a lockable sliding door system, a retrofit locking system for installation on existing sliding doors, and a method for making and using both.

The system of the present teachings can include, but is not limited to, a security bar having a first end and a second end, the first end having a shaft hole, and a door handle having a handle shaft. The security bar and door handle are configured to be installed on the sliding door by inserting the handle shaft through a hole on a stationary portion of the sliding door and connecting the handle shaft to the shaft hole of the security bar on the inside of the stationary portion. The door handle is configured to pivot the second end of the security bar such that in a first position it is substantially vertical and allows a sliding portion of the sliding door to slide, and in a second position the security bar is substantially horizontal and engages the sliding portion to restrict it from sliding.

In an alternate embodiment, the sliding door lock system of the present teachings can include, but is not limited to including, a security bar having a proximal end and a distal end, the security bar being rotatably mounted at the proximal end at a location on an interior side of a stationary portion of a sliding door, the sliding door having the stationary portion and a sliding portion, a door handle shaft extending from the interior side to an exterior side of the stationary portion through a recess in the stationary portion, the door handle shaft having an interior end and an exterior end, the door handle shaft interior end being secured to the security bar proximal end, and a door handle mounted on the exterior side, the door handle being matably attached to the door handle shaft exterior end, wherein the door handle and the door handle shaft enable the security bar to lock the sliding door.

In a further alternate embodiment, the door lock kit for a sliding door of the present teachings can include, but is not limited to including, a security bar having a first end and a second end, the first end having a shaft hole, a door handle having a handle shaft, the handle shaft configured to matably attach to the first end through the shaft hole, the door handle being configured to pivot the security bar, and a strike plate configured for attachment to the sliding door, the strike plate configured to accept the second end.

The method of manufacturing the present embodiment may include, although not limited thereto, the steps of rotatably attaching a security bar to the interior side of the sliding door, drilling a hole in the stationary portion of the sliding door, inserting a door handle shaft having an interior end and an opposing exterior end into the hole from the exterior side to the interior side, the interior end being positioned proximal to the interior side, matably attaching the security bar to the door handle shaft interior end, and matably attaching a door handle to the door handle shaft exterior end.

The method using the present embodiment may include, although not limited thereto, the steps of operating a door handle attached to the outside of a stationary portion of the sliding door to orientate a security bar attached to the inside of the stationary portion into a substantially horizontal position so that the security bar engages a sliding portion of the sliding door to restrict the sliding portion from sliding. The door handle may then be locked with a key.

Other embodiments of the system and method are described in detail below and are also part of the present teachings.

For a better understanding of the present embodiments, together with other and further aspects thereof, reference is made to the accompanying drawings and detailed description.

### BRIEF DESCRIPTION OF THE DRAWINGS

FIG. 1 is a pictorial view of one embodiment of the security bar of the present teachings;

FIG. 2 is a pictorial view of one embodiment of the strike plate of the present teachings;

FIG. 3 is a pictorial of the front view of one embodiment of the door handle used to operate the security bar of the present teachings;

FIG. 4 is a pictorial of the transverse view of one embodiment of the door handle used to operate the security bar of the present teachings;

FIG. 5 is a pictorial view of the inside of a sliding door employing one embodiment of the lock system of the present teachings;

FIG. 6 is a pictorial view of the outside of a sliding door employing one embodiment of the lock system of the present teachings; and

FIG. 7 is an edge view of a sliding door employing one embodiment of the lock system of the present teachings.

FIG. 8 is a flowchart of the method of manufacture of the sliding door lock of the present embodiment; and

FIG. 9 is a pictorial view of the components of the sliding door lock kit of the present embodiment.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

In one embodiment of the present invention, the lock system for sliding doors disclosed herein comprises a security bar on the inside of the sliding door connected to a door handle on the outside of the sliding door. The door handle may control the rotation of the security bar about a point along its length such that in a first position it allows the sliding portion to slide and in a second position it restricts the sliding portion from sliding. The door handle on the outside of the sliding door may allow a user to lock the security bar in place with a key, although not limited thereto. A system so constructed permits control of the security bar from both inside and outside.

A security bar may be manufactured from, for example, but not limited to, aluminum square bar. Such a configuration provides a lightweight, easy-to-use and effective locking mechanism. One end of a security bar may be affixed to any portion of the sliding door such that it may prevent the sliding portion from moving when engaged. For example, one end of a security bar may be affixed to the door jamb or to the stationary portion of the sliding door, although not limited thereto.

A strike plate may be used with the security bar, although not limited thereto. The strike plate may be adjacent to the sliding portion of the sliding door so that it cradles the security bar in the locked position to hold the security bar and restrict the sliding portion from opening. For example, the strike plate may be positioned on the back of the sliding portion of the sliding door, although not limited thereto. The strike plate may be a slotted metal plate with a recess for the security bar, although not limited thereto.

The strike plate may also incorporate locking pin and pin holes so that the security bar may be locked into place from the inside, preventing the security bar from being operated by the door handle from the outside. The locking pin may be a ball push pin, although not limited thereto, which may engage holes in the strike plate so that when inserted the locking pin prevents the security bar from disengaging the strike plate. The locking pin may be attached to the strike plate with a section of chain or some similar device so that it is always available for immediate use.

The door handle may comprise a lever handle lock, although not limited thereto. The door handle may control the operation of the security bar so that it can be rotated between a locked position and an unlocked position. The door handle may have a key lock on the outside and a button or some other mechanism for controlling the lock on the inside, although not limited thereto.

The door handle and lock may also incorporate torqueing technology that provides the ability to easily manipulate the position of a very large security bar. With heavy or long security bars, additional torque may be required to easily operate the system from the outside door handle. The door handle is designed to compensate for the additional torque in order to ease operation of security bar.

The security bar may also be motorized, although not limited thereto. In such a way, the security bar may be controlled by an electric motor or some similar device, and a button or other control mechanism may send a signal to rotate the security bar between the locked and unlocked positions. The lock system may also incorporate a wireless control mechanism so that a user outside of the house may easily control the motorized security bar, although not limited thereto.

The lock system of the present teachings may be sold in a kit form so that existing sliding doors may be retro-fitted with these superior locking capabilities. The kit may include, but is not limited to, a door handle, a security bar, a strike plate, a locking pin, a chain or other means for flexibly securing the locking pin to the sliding door, a key fitted to a key lock in the door handle, screws or other means for securing the door handle and the strike plate to the sliding door, templates for installation and instructions. The a door handle may also be equipped with an additional mechanism for locking and unlocking the door from the inside.

In the alternative, although not limited thereto, sliding doors may be sold already incorporating this technology so that consumers do not have to install it themselves.

The lock system may also incorporate a stabilizing mechanism to stabilize the security bar between its locked and unlocked positions. In one embodiment of the lock system, the security bar may be pivotally connected to the sliding door. Stabilizing means may keep the security bar stabilized so that it cannot move from a position substantially parallel to the sliding door, thus possibly missing a strike plate when lowered into the locked position, although not limited thereto.

The lock system of the present embodiment is discussed below in terms of sliding glass doors, which are common in residences to provide entry as well as views of the outside. But sliding doors are not limited to glass, nor are they limited to residences. For example, although not limited thereto, applications may include bar doors and room dividers for homes, hotels, and businesses. In fact, anywhere where a sliding access point is used is a potential application for the present teachings.

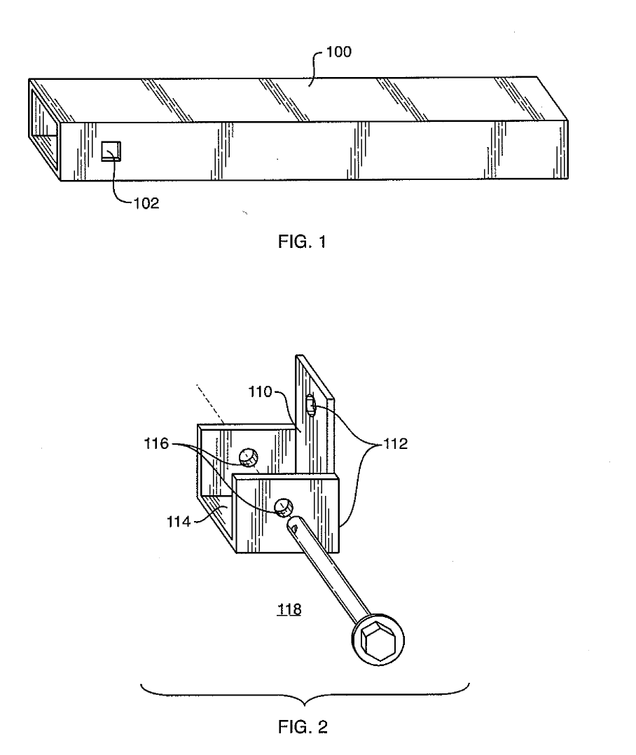

Referring now to FIG. 1, shown is a pictorial view of one embodiment of a security bar 100. The security bar 100 may be manufactured with a shaft hole 102 to receive the handle shaft 132 of the door handle 120 (both shown in FIG. 4). The shaft hole 102 may be a square slotted hole, although not limited thereto. For example, it may be rectangular, triangular, or some other shape. Similarly, the security bar 100 may be in any number of shapes. Operation of the door handle 120 may rotate the handle shaft 132 and the security bar 100 so that it may move between a locked and unlocked position. The security bar 100 may be manufactured from square aluminum bar, although not limited thereto.

Referring now to FIG. 2, shown is a pictorial view of one embodiment of a strike plate 110. The strike plate 110 may have mounting holes 112 for mounting on the sliding door. In one embodiment, the strike plate 110 may be mounted on the sliding portion of the sliding door. When in the locked position, one end of the security bar 100 (shown in FIG. 1) may rest in a recess 114 of the strike plate 110. In such a way, the security bar 100 is held in place in the locked position.

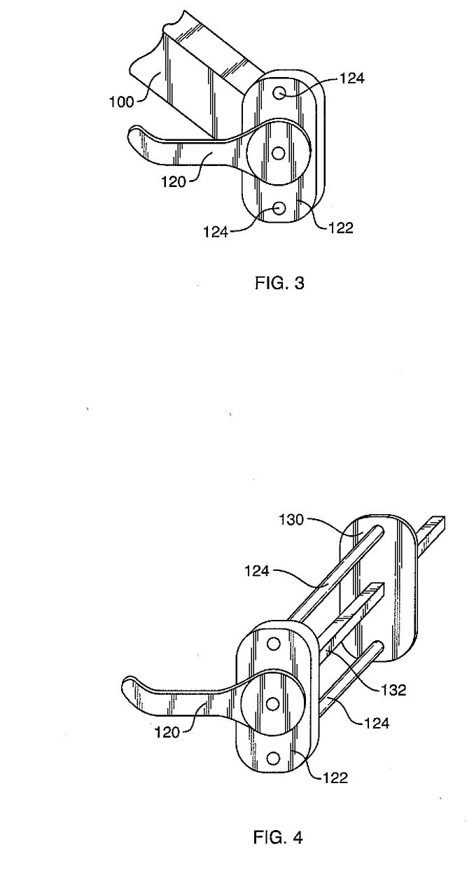

The strike plate may also incorporate a locking pin 118, which engages pin holes 116 to secure one end of the security bar 100 on the strike plate 110. When the locking pin 118 engages the strike plate 110, the security bar may not be operated by the door handle 120 (shown in FIG. 3) on the outside of the sliding door. The locking pin 118 may be a ball push pin, although not limited thereto.

Referring now to FIG. 3, shown is a pictorial of the front view of one embodiment of a door handle 120 used to operate a security bar 100. The door handle 120 may be on the outside of the sliding door and the security bar 100 may be on the inside. Mounting screws 124 may be used to mount the door handle 120 and outside mounting plate 122 to the sliding door. Once installed, the door handle 120 may be used to operate the security bar 100 between the locked position and the unlocked position.

Referring now to FIG. 4, shown is a pictorial of the transverse view of one embodiment of a door handle 120 used to operate a security bar 100 (shown in FIG. 3). The door handle 120 and outside mounting plate 122 may be installed on the outside of the sliding door with mounting screws 124 which connect with an inside mounting plate 130 on the inside of the sliding door. The door handle 120 may control the handle shaft 132 which may pass through a portion of the sliding door and operates the security bar 100.

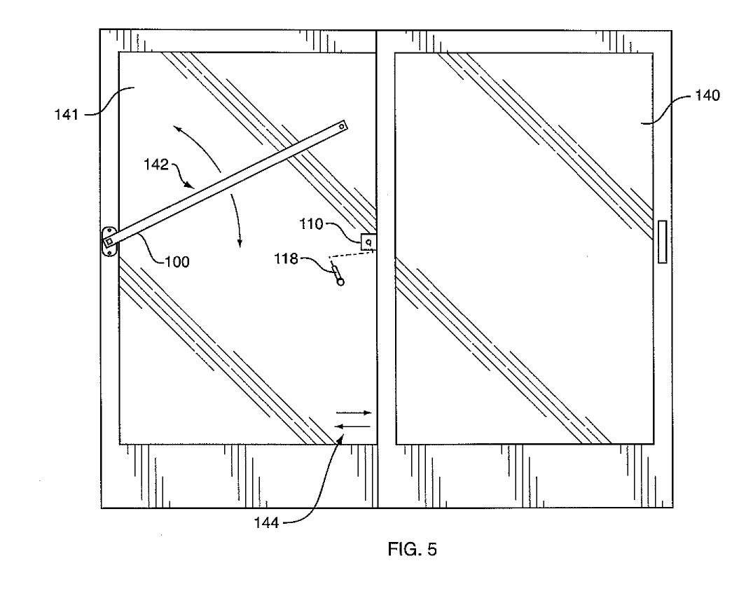

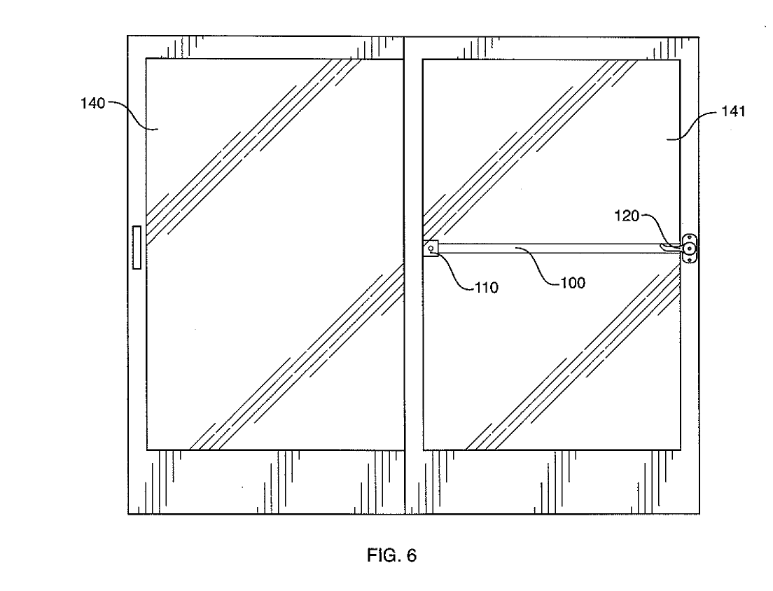

Referring now to FIG. 5, shown is a pictorial view of the inside of a sliding door employing one embodiment of the lock system. A sliding door may have both a sliding portion 140 and a stationary portion 141. The sliding portion 140 has door movement 144 which allows it to slide left and right in its regular operation. The security bar 100 may be installed so that it rotates about a point along its length, giving it bar movement 142 between a locked and unlocked position. For example, when in the unlocked position, the security bar may be in substantially vertical position so as not to affect door movement 144. In the locked position, the security bar 100 may be in a substantially horizontal position and engages the sliding portion 140 such that it restricts door movement 144.

A strike plate 110 may hold the security bar 100 when it is in its locked position by providing a recess 114 (shown in FIG. 2) in which the end of the security bar rests. The strike plate 110 may have ball bearings or some other means for assisting the security bar 100 into position such as an angled recess 114, although not limited thereto. The security bar 100 may be further secured in its locked position with a locking pin 118 that engages the strike plate 110. The locking pin 118 may be connected to the strike plate 110 with a chain or some similar device so that it is available when needed.

To use the lock system, a user may position the security bar 100 against the strike plate 110 and insert the locking pin 118 into the pin holes 116 (shown in FIG. 2). However, the locking pin 118 should not be used when a user intends to operate the sliding door from the outside. In order to unlock the sliding door from the inside, the user may remove the locking pin 118 and lift the security bar 100 to allow door movement 144. The lock system may be locked from the outside by closing the sliding portion 140 and using the door handle 120 (shown in FIG. 6) to position the security bar 100 in a locked position. A user may then use a key to lock the door handle 120, although not limited thereto. Similarly, the door handle 120 may be unlocked from the outside and the security bar 100 rotated to its unlocked position. The door handle 120 may also have a mechanism for locking and unlocking it from the inside such as a button or a switch, although not limited thereto

Referring now to FIG. 6, shown is a pictorial view of the outside of a sliding door employing one embodiment of the lock system. The door handle 120 on the outside of the sliding door permits operation of a security bar 100 on the inside. As shown, the security bar 100 is in the locked position with one end resting on a strike plate 110. The door handle 120 allows the security bar 100 to be positioned to its unlocked position so that the sliding portion 140 of the sliding door may operate without restriction.

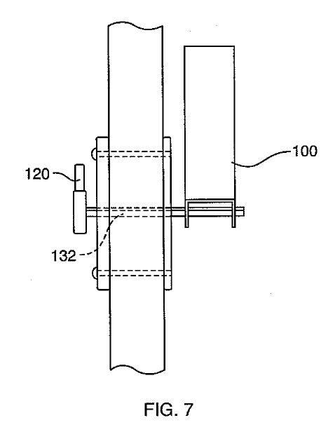

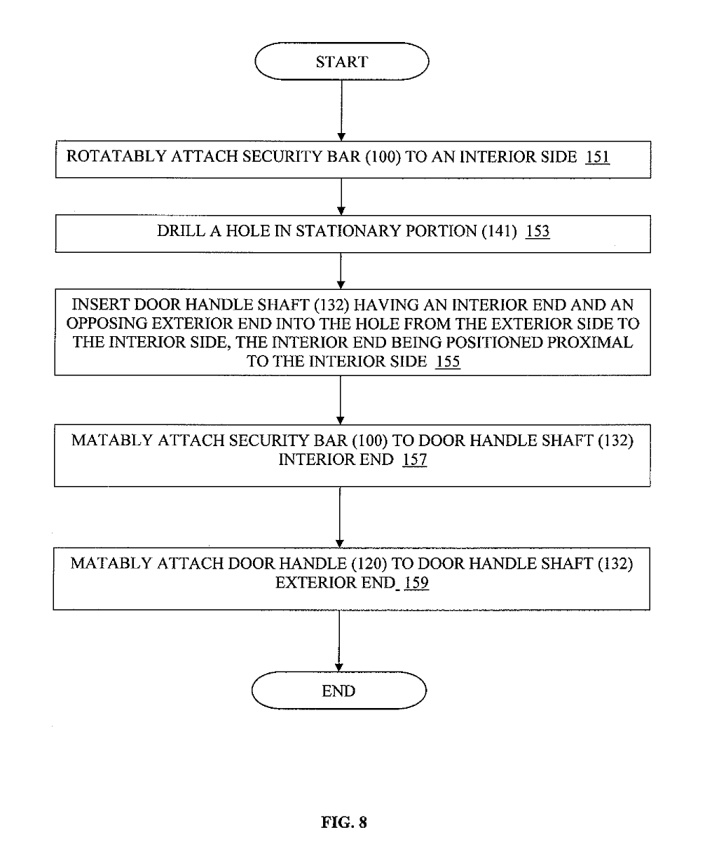

Referring now to FIG. 7, shown is an end view of a sliding door employing one embodiment of the lock system. Operation of the door handle 120 controls the handle shaft 132, which in turn moves the security bar 100 between the locked (e.g., horizontal) and unlocked (e.g., vertical) position. A door handle 120 permits the security bar 100 to be controlled from the outside.

Referring now to FIG. 8, method 150 for manufacturing a sliding door having an interior side and an exterior side, the sliding door having a stationary portion and a sliding portion, the method can include, but is not limited to including, the steps of rotatably 151 attaching a security bar to the interior side, drilling 153 a hole in the stationary portion, inserting 155 a door handle shaft having an interior end and an opposing exterior end into the hole from the exterior side to the interior side, the interior end being positioned proximal to the interior side, matably attaching 157 the security bar to the door handle shaft interior end, and matably attaching 159 a door handle to the door handle shaft exterior end. Method 150 can optionally include the step of securing the door handle to the stationary portion.

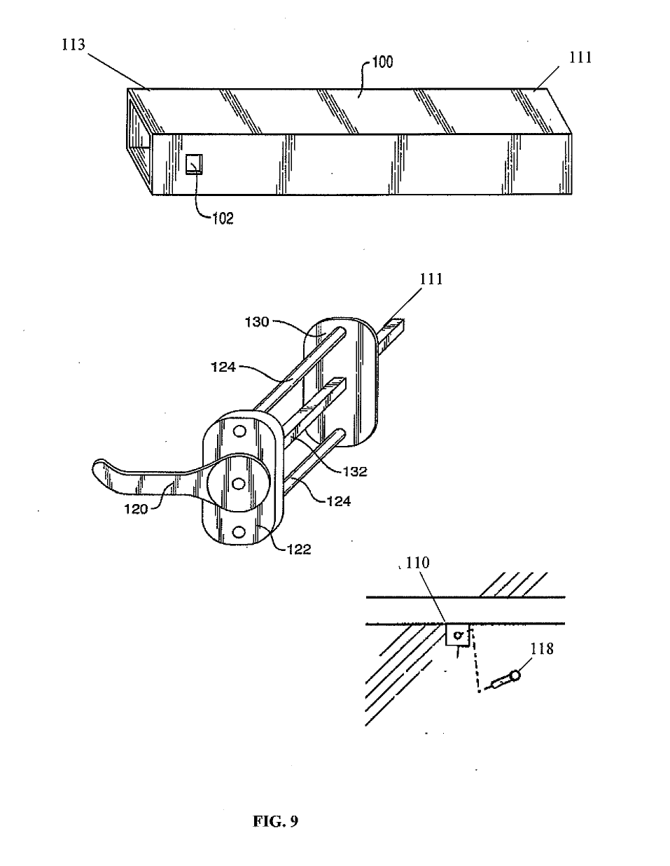

Referring now to FIG. 9, the kit of the present embodiment can include, but is not limited to including, security bar 100 having first end 113 and second end 111, first end 113 having shaft hole 102, door handle 120 having handle shaft 132, handle shaft 132 being configured to matably attach to first end 113 through shaft hole 102, door handle 120 being configured to pivot security bar 100, and strike plate 110 configured for attachment to sliding door, strike plate 110 configured to accept second end 111.

While the present teachings have been described above in terms of specific embodiments, it is to be understood that they are not limited to these disclosed embodiments. Many modifications and other embodiments will come to mind to those skilled in the art to which this pertains, and which are intended to be and are covered by this disclosure. It is intended that the scope of the present teachings should be determined by proper interpretation and construction of the disclosure and its legal equivalents, as understood by those of skill in the art relying upon this specification and the attached drawings.

What is claimed is:

1. A sliding door lock system comprising:
a security bar rotatably mounted at a location on an interior side of a sliding door, the sliding door having a stationary portion and a sliding portion, the security bar being integrally configured with a door handle mounted on an exterior side of the sliding door;
wherein the door handle controls the rotation of the security bar.

2. The system of claim 1, wherein the security bar comprises aluminum square bar.

3. The system of claim 1, wherein the location comprises a door jamb associated with the sliding door.

4. The system of claim 1, wherein the location comprises the stationary portion of the sliding door.

5. The system of claim 1, further comprising a strike plate positioned adjacent to the sliding portion, the strike plate cradling the security bar when the security bar is in a locked position.

6. The system of claim 5, wherein the strike plate comprises a slotted metal plate.

7. The system of claim 5, wherein the strike plate comprises pin holes and a locking pin capable of engaging the pin holes.

8. The system of claim 1, wherein the door handle further comprises a key lock.

9. The system of claim 8, wherein the key lock further comprises a key fitted to the key lock.

10. A method for manufacturing a sliding door having an interior side and an exterior side, the sliding door having a stationary portion and a sliding portion, the method comprising the steps of:
rotatably attaching a security bar to the interior side;
drilling a hole in the stationary portion;
inserting a door handle shaft having an interior end and an opposing exterior end into the hole from the exterior side to the interior side, the interior end being positioned proximal to the interior side;
matably attaching the security bar to the door handle shaft interior end; and
matably attaching a door handle to the door handle shaft exterior end.

11. The method of claim 10 further comprising the step of:
securing the door handle to the stationary portion.

12. A door lock kit for a sliding door, comprising:
a security bar having a first end and a second end, the first end having a shaft hole;
a door handle having a handle shaft, the handle shaft configured to matably attach to the first end through the shaft hole, the door handle being configured to pivot the security bar; and
a strike plate configured for attachment to the sliding door, the strike plate configured to accept the second end.

13. The door lock kit of claim 12, wherein the door handle comprises a key lock.

14. The door lock kit of claim 13, wherein the key lock comprises a key fitted to the key lock.

15. The door lock kit of claim 12, wherein the strike plate comprises pin holes and a locking pin capable of engaging the pin holes.

16. The door lock kit of claim 12, further comprising one or more templates for installation.

17. The door lock kit of claim 12, further comprising means for securing the door handle and the strike plate to the sliding door.

18. The door lock kit of claim 12, further comprising directions for installation.

19. A sliding door, comprising:
a stationary portion, having an outside, an opposing inside, an outside edge and an opposing inside edge;
a security bar having a first end and a second end, the first end having a shaft hole;
a door handle attached to the outside, the door handle having a handle shaft proceeding through the stationary portion and engaging a shaft hole on the first end of the security bar;
a sliding portion adjacent to the stationary portion at the inside edge when the sliding door is in a locked position; and
a strike plate secured to the sliding portion, the security bar second end being lodged against the strike plate when the sliding door is in the locked position,
wherein the door handle is configured to control the security bar when the sliding door is in the locked position.

20. The sliding door of claim 19, wherein the sliding door is a glass patio door.

21. The sliding door of claim 19, wherein the door handle comprises a key lock.

22. The sliding door of claim 19, wherein the strike plate comprises pin holes and a locking pin configured to engage the pin holes.

23. The sliding door of claim 21, wherein the key lock comprises a key fitted to the key lock.
